(19) United States
(12) Patent Application Publication
(10) Pub. No.: US 2014/0265876 A1
(43) Pub. Date: Sep. 18, 2014

(54) Automatic Color Balancing of Light-Emitting Diode-Based Lighting

(71) Applicants: Gerald Ho Kim, Carlsbad, CA (US); Jay Eunjae Kim, Issaquah, WA (US)

(72) Inventors: Gerald Ho Kim, Carlsbad, CA (US); Jay Eunjae Kim, Issaquah, WA (US)

(21) Appl. No.: 13/831,544

(22) Filed: Mar. 14, 2013

(51) Int. Cl. H05B 33/08

(52) U.S. Cl. CPC H05B 33/0872
USPC 315/153

(57) ABSTRACT

Apparatus and method of color balancing LED-based lighting are provided. In one aspect, an apparatus comprises an image sensor that senses images of objects, an illumination device, and control logic. The illumination device comprises an LED that emits red light, an LED that emits green light, and an LED that emits blue light. The control logic receives an imaging signal from the image sensor related to a sensed image of a first object that is illuminated by the illumination device. The control logic controls color balancing of light emitted by the illumination device according to an optical characteristic of the image of the first object.

### BACKGROUND

1. Technical Field

The present disclosure generally relates to the field of lighting and, more particularly, to the automatic color balancing of light-emitting diode (LED) lighting based on a desired wavelength.

2. Description of the Related Art

Compared with conventional light sources such as ordinary incandescent light bulbs and halogen lamps, light-emitting diodes (LEDs) generally offer a number of advantageous characteristics such as longer product life, more compact size, higher shock resistance, lower heat generation and lower power consumption, etc. As a result LEDs are widely employed in a variety of applications as the light source for illumination or indicator of a variety of equipment. Recent developments of new LEDs are in the areas of multiple colors and high brightness. Accordingly, LEDs are further employed in applications such as large outdoor bulletin boards, traffic signals and related fields. In the future, LEDs may even become the primary light source for illumination that not only conserve electricity but also are environmentally friendly.

One trend is to use LEDs as a light source for illumination in medical applications. For instance, surgical headlights based on LEDs for use by surgeons have recently been introduced to the market. However, when the light is shone on an object that a surgeon desires to observe, the light may be too bright thus making it difficult to distinguish the object from its background and/or surrounding objects. It may also be difficult to observe the color of the object in contrast with its background and/or surrounding objects.

There is, therefore, a need to provide an illumination device that resolves the aforementioned problems.

### SUMMARY

Various embodiments of apparatus and method that color-balance LED-based lighting are provided.

According to one aspect, an apparatus may comprise an image sensor that senses images of objects, an illumination device, and control logic. The illumination device may comprise an LED that emits red light, an LED that emits green light, and an LED that emits blue light. The control logic may receive an imaging signal from the image sensor related to a sensed image of a first object that is illuminated by the illumination device. The control logic may control color balancing of light emitted by the illumination device according to an optical characteristic of the image of the first object.

In some embodiments, the control logic may control the color balancing of the light emitted by the illumination device to adjust a color contrast between the first object and a background or a second object in the image.

In some embodiments, the control logic may control the color balancing of the light emitted by the illumination device by controlling a respective intensity of light emitted by each of the LEDs of the illumination device to adjust a color contrast between the first object and a background or a second object in the image.

In some embodiments, the control logic may control the color balancing of the light emitted by the illumination device by controlling a respective duty cycle of time during which light is emitted by each of the LEDs of the illumination device to adjust a color contrast between the first object and a background or a second object in the image.

In some embodiments, the image sensor may comprise a charge-coupled device (CCD).

In some embodiments, the image sensor may comprise a complementary metal-oxide-semiconductor (CMOS) active pixel sensor.

In some embodiments, the control logic may comprise a computing device and a controller. The computing device may be coupled to receive the imaging signal from the image sensor and provides a control signal in response to receiving the imaging signal. The controller may be coupled to the computing device and the illumination device. The controller may receive the control signal and respectively control an intensity or a duty cycle of electric power supplied to each of the LEDs of the illumination device based on the control signal.

In some embodiments, the apparatus may further comprise a light guide device including a hollow light pipe portion, an opening, and a distal end longitudinally opposite from the opening. The opening may be configured to receive the illumination device therein. Either or both of the light pipe portion and the distal end may have a textured surface thereof that permits a predetermined portion of the light emitted by the illumination device to illuminate through the textured surface.

According to another aspect, a method of optimizing a color contrast of a first object may comprise: illuminating the first object with an illumination device comprising an LED that emits red light, an LED that emits green light, and an LED that emits blue light; receiving an imaging signal from an image sensor, the imaging signal related to a sensed image of the first object; and controlling color balancing of light emitted by the illumination device according to an optical characteristic of the image of the first object.

In some embodiments, controlling the color balancing of the light emitted by the illumination device may comprise controlling the color balancing of the light emitted by the illumination device to adjust a color contrast between the first object and a background or a second object in the image.

In some embodiments, controlling the color balancing of the light emitted by the illumination device may comprise controlling a respective intensity of light emitted by each of the LEDs of the illumination device to adjust a color contrast between the first object and a background or a second object in the image.

In some embodiments, controlling the color balancing of the light emitted by the illumination device may comprise controlling a respective duty cycle of time during which light is emitted by each of the LEDs of the illumination device to adjust a color contrast between the first object and a background or a second object in the image.

This summary is provided to introduce concepts relating to apparatus and method of color balancing LED-based lighting. The proposed techniques are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a perspective view of an unassembled apparatus in accordance with one embodiment of the present disclosure.

FIG. 2 is a close-up view of section A of FIG. 1.

FIG. 3 is a process of optimizing a color contrast of a first object in accordance with one embodiment of the present disclosure.

### DETAILED DESCRIPTION OF PREFERRED EMBODIMENTS

### Overview

The present disclosure describes embodiments of an apparatus, and a method thereof, that color-balances LED-based lighting to optimize the color contrast of an object. The disclosed apparatus comprises an image sensor that senses images of objects, an illumination device, and control logic. The illumination device comprises an LED that emits red light, an LED that emits green light, and an LED that emits blue light. The control logic receives an imaging signal from the image sensor related to a sensed image of a first object that is illuminated by the illumination device. The control logic controls color balancing of light emitted by the illumination device according to an optical characteristic of the image of the first object. Accordingly, given the feedback from the image sensor, color balancing of the emitted light can be dynamically and automatically adjusted in real-time to accommodate for changes in the ambient lighting to achieve high contrast of the first object. Settings of the color balancing of the emitted light can be programmed for more frequent scenarios. The color balancing can also be manually adjusted by a user.

While aspects of the disclosed embodiments and techniques may be implemented in any number of different applications, for the purpose of illustration the disclosed embodiments are described in context of the following exemplary configurations.

### Illustrative Apparatus

FIG. 1 illustrates an unassembled apparatus 101 in accordance with one embodiment of the present disclosure. FIG. 2 is a close-up view of section A of FIG. 1.

The apparatus 101 comprises an image sensor 17 that senses images of objects, an illumination device 18, and control logic. The control logic may be implemented with a combination of software and hardware including, but not limited to, a processor such as an integrated circuit (IC), memory coupled to the processor, and necessary circuitry and wiring. In the example shown in FIG. 1, the control logic is implemented as a computing device 16 and a light source driver or lighting controller 15. Although FIG. 1 shows the computing device 16 and the lighting controller 15 as separate and discrete objects, in other embodiments they may be integrated and implemented as a single object with the necessary software stored therein. In the example shown in FIG. 1, the image sensor 17 is coupled to the control logic, e.g., the computing device 16, via wiring 21. The computing device 16 is coupled to the lighting controller 15 via wiring 20. The illumination device is coupled to the lighting controller 16 via wiring 19.

The illumination device 18 comprises an LED 11 that emits red light, an LED 12 that emits green light, and an LED 13 that emits blue light. The control logic, e.g., the computing device 16, receives an imaging signal from the image sensor 17 related to a sensed image of a first object that is illuminated by the illumination device 18. The control logic, e.g., the computing device 16 via the lighting controller 15, controls color balancing of light emitted by the illumination device 18 according to an optical characteristic of the image of the first object. The optical characteristic may be, for example, the chromatic balance (or color balance) of the lighting.

In some embodiments, the control logic, e.g., the computing device 16 via the lighting controller 15, controls the color balancing of the light emitted by the illumination device 18 to adjust a color contrast between the first object and a background or a second object in the image. For example, in a medical application such as when illuminating a certain organ inside the body cavity of a patient, light emitted by the LEDs 11, 12, 13 of the illumination device 18 can be color balanced to provide a high contrast between the first object, which may be what the surgeon desires to observe, and its background and/or surrounding.

In some embodiments, the control logic, e.g., the computing device 16 via the lighting controller 15, controls the color balancing of the light emitted by the illumination device 18 by controlling a respective intensity of light emitted by each of the LEDs 11, 12, 13 of the illumination device 18 to adjust a color contrast between the first object and a background or a second object in the image. For example, in response to the imaging signal from the image sensor 17, the computing device 16 sends a control signal to the lighting controller 15 which in turn controls the current supplied to each of the LEDs 11, 12, 13 to affect the lighting. To illustrate the point, the first object is assumed to be of red color. In such case, the computing device 16 may direct the lighting controller 15 to supply a relatively higher current to the red LED 11 while supplying a relatively lower current to each of the green LED 12 and the blue LED 13. This would help create a stronger contrast between the red object and anything in its surrounding and background that is not red.

In some embodiments, the control logic, e.g., the computing device 16 via the lighting controller 15, controls the color balancing of the light emitted by the illumination device 18 by controlling a respective duty cycle of time during which light is emitted by each of the LEDs 11, 12, 13 of the illumination device 18 to adjust a color contrast between the first object and a background or a second object in the image. For example, in response to the imaging signal from the image sensor 17, the computing device 16 sends a control signal to the lighting controller 15, which may contain a pulse width modulator (PWM) for example, and the lighting controller 15 controls the duty cycle during which each of the LEDs 11, 12, 13 is turned on to affect the lighting. Still assuming the first object is of red color, in such case the computing device 16 may direct the lighting controller 15 to lengthen the duty cycle during which the red LED 11 is turned on while shortening or not changing the duty cycle of each of the green LED 12 and the blue LED 13. This would help create a stronger contrast between the red object and anything in its surrounding and background that is not red.

In some embodiments, the image sensor 17 comprises a charge-coupled device (CCD). Alternatively, the image sensor 17 comprises a complementary metal-oxide-semiconductor (CMOS) active pixel sensor.

In some embodiments, in addition to or in lieu of automatic adjustment based on the feedback, i.e., the imaging signal, from the image sensor, the lighting controller 15 of the control logic may be manually adjusted by the user to manually set the color balancing of the red, green and blue lights emitted by the LEDs 11, 12, 13.

In some embodiments, the control logic, e.g., the computing device 16 or the lighting controller 15, includes memory, such as a flash memory chip or random-access memory (RAM) for example, to store settings for color balancing the LEDs 11, 12, 13 to allow the user to select from among a plurality of settings for each of a plurality of frequent lighting scenarios. This would save the user time that would be spent in adjusting the color balancing of the lighting by directly adjust the color balancing to the predetermined setting for the particular lighting scenario at hand.

In some embodiments, the apparatus 101 further comprises a light guide device 14 that includes a hollow light pipe portion, an opening, and a distal end longitudinally opposite from the opening. The opening may be configured to receive a portion of the illumination device 18, such as the LEDs 11, 12, 13, therein. Either or both of the light pipe portion and the distal end of the light guide device 14 may include a textured surface thereof that permits a predetermined portion of the light emitted by the illumination device 18 to illuminate through the textured surface.

### Illustrative Method

FIG. 3 is a process 300 of optimizing a color contrast of a first object in accordance with one embodiment of the present disclosure.

At 302, the process 300 illuminates the first object with an illumination device comprising an LED that emits red light, an LED that emits green light, and an LED that emits blue light. At 304, the process 300 receives an imaging signal from an image sensor, the imaging signal related to a sensed image of the first object. At 306, the process 300 controls color balancing of light emitted by the illumination device according to an optical characteristic of the image of the first object.

The process 300 may be carried out using the apparatus 101 of FIG. 1. For example, the illumination device 18 of the apparatus 101 can illuminate the first object. The image sensor 17 of the apparatus 101 can provide the imaging signal which is received by the control logic, e.g., the computing device 16. The control logic, e.g., the computing device 16 and the lighting controller 15, can control color balancing of the light emitted by the illumination device 18 according to an optical characteristic of the image of the first object.

In some embodiments, controlling the color balancing of the light emitted by the illumination device may comprise controlling the color balancing of the light emitted by the illumination device to adjust a color contrast between the first object and a background or a second object in the image.

In some embodiments, controlling the color balancing of the light emitted by the illumination device may comprise controlling a respective intensity of light emitted by each of the LEDs of the illumination device to adjust a color contrast between the first object and a background or a second object in the image.

In some embodiments, controlling the color balancing of the light emitted by the illumination device may comprise controlling a respective duty cycle of time during which light is emitted by each of the LEDs of the illumination device to adjust a color contrast between the first object and a background or a second object in the image.

### CONCLUSION

The above-described techniques pertain to color balancing LED-based lighting to optimize the color contrast of an object. Although the techniques have been described in language specific to certain applications, it is to be understood that the appended claims are not necessarily limited to the specific features or applications described herein. Rather, the specific features and applications are disclosed as exemplary forms of implementing such techniques. For instance, although the techniques have been described in the context of medical applications, the techniques may be applied in any other suitable context.

What is claimed is:

1. An apparatus comprising:
an image sensor that senses images of objects;
an illumination device comprising a light-emitting diode (LED) that emits red light, an LED that emits green light, and an LED that emits blue light; and
control logic coupled to receive an imaging signal from the image sensor related to a sensed image of a first object that is illuminated by the illumination device, the control logic further coupled to control color balancing of light emitted by the illumination device according to an optical characteristic of the image of the first object.

2. The apparatus of claim 1, wherein the control logic controls the color balancing of the light emitted by the illumination device to adjust a color contrast between the first object and a background or a second object in the image.

3. The apparatus of claim 1, wherein the control logic controls the color balancing of the light emitted by the illumination device by controlling a respective intensity of light emitted by each of the LEDs of the illumination device to adjust a color contrast between the first object and a background or a second object in the image.

4. The apparatus of claim 1, wherein the control logic controls the color balancing of the light emitted by the illumination device by controlling a respective duty cycle of time during which light is emitted by each of the LEDs of the illumination device to adjust a color contrast between the first object and a background or a second object in the image.

5. The apparatus of claim 1, wherein the image sensor comprises a charge-coupled device (CCD).

6. The apparatus of claim 1, wherein the image sensor comprises a complementary metal-oxide-semiconductor (CMOS) active pixel sensor.

7. The apparatus of claim 1, wherein the control logic comprises:
a computing device coupled to receive the imaging signal from the image sensor and provides a control signal in response to receiving the imaging signal; and
a controller, coupled to the computing device and the illumination device, that receives the control signal and respectively controls an intensity or a duty cycle of electric power supplied to each of the LEDs of the illumination device based on the control signal.

8. The apparatus of claim 1 further comprising:
a light guide device including a hollow light pipe portion, an opening, and a distal end longitudinally opposite from the opening, the opening configured to receive the illumination device therein, either or both of the light pipe portion and the distal end having a textured surface thereof that permits a predetermined portion of the light emitted by the illumination device to illuminate through the textured surface.

9. A method of optimizing a color contrast of a first object, the method comprising:
illuminating the first object with an illumination device comprising a light-emitting diode (LED) that emits red light, an LED that emits green light, and an LED that emits blue light;
receiving an imaging signal from an image sensor, the imaging signal related to a sensed image of the first object; and
controlling color balancing of light emitted by the illumination device according to an optical characteristic of the image of the first object.

10. The method of claim 9, wherein controlling the color balancing of the light emitted by the illumination device comprises controlling the color balancing of the light emitted by the illumination device to adjust a color contrast between the first object and a background or a second object in the image.

11. The method of claim 9, wherein controlling the color balancing of the light emitted by the illumination device comprises controlling a respective intensity of light emitted by each of the LEDs of the illumination device to adjust a color contrast between the first object and a background or a second object in the image.

12. The method of claim 9, wherein controlling the color balancing of the light emitted by the illumination device comprises controlling a respective duty cycle of time during which light is emitted by each of the LEDs of the illumination device to adjust a color contrast between the first object and a background or a second object in the image.
